(19) United States
(12) Patent Application Publication
(10) Pub. No.: US 2023/0066239 A1
(43) Pub. Date: Mar. 2, 2023

(54) POLYAMIDEIMIDE RESIN COMPOSITION AND FLUORINE-CONTAINING COATING MATERIAL

(71) Applicant: SHOWA DENKO MATERIALS CO., LTD., Tokyo (JP)

(72) Inventor: Atsushi TAKAHASHI, Hitachi-shi (JP)

(73) Assignee: SHOWA DENKO MATERIALS CO., LTD., Tokyo (JP)

(21) Appl. No.: 17/981,060

(22) Filed: Nov. 4, 2022

Related U.S. Application Data
(63) Continuation of application No. 16/635,314, filed on Jan. 30, 2020.

(30) Foreign Application Priority Data
Aug. 1, 2017 (JP) 2017-149181

(51) Int. Cl. C08L 79/08; C09D 127/18; C09D 127/20; C09D 179/08; C08K 5/357; C08G 73/14

(52) U.S. Cl. CPC C08L 79/08; C09D 127/18; C09D 127/20; C09D 179/08; C08K 5/357; C08G 73/14; C08K 5/07

(57) ABSTRACT

A polyamideimide resin composition containing a polyamideimide resin (A), 4-morpholine carbaldehyde (B), water (C), and a basic compound (D), wherein the change in viscosity of the composition from before storage to after storage at 60° C. for 7 days is within −30%.

### TECHNICAL FIELD

One embodiment of the present invention relates to a polyamideimide resin composition. Other embodiments of the present invention relate to a fluorine-containing coating material that contains the polyamideimide resin composition, and use of that fluorine-containing coating material.

### BACKGROUND ART

polyamideimide resins exhibit excellent heat resistance, chemical resistance and solvent resistance, and are therefore widely used in a variety of applications as coating agents and the like for all manner of substrates. For example, polyamideimide resins can be used favorably as materials for enameled wire varnishes and heat-resistant coating materials and the like.

In various applications, polar solvents such as N-methyl-2-pyrrolidone are well known as the solvents generally used for dissolving and diluting polyamideimide resins, and as the solvents for synthesizing polyamideimide resins. Among these solvents, N-methyl-2-pyrrolidone (NMP) is capable of imparting excellent solubility to polyamideimide resins, and is widely used as a preferred solvent.

However, in recent years, from the viewpoints of environmental preservation, safety and hygiene, regulations regarding the use of organic solvents are becoming increasingly strict. In response to these regulations, and from the viewpoints of economic viability and coating workability as well as the above viewpoints of environmental preservation, safety and hygiene, aqueous resin solutions that use water as the solvent medium instead of an organic solvent are attracting considerable attention. For example, a method for converting a polyamideimide resin to a water-soluble form by reacting a basic compound with the residual carboxyl groups at the resin terminals has been reported (Patent Document 1), and is being used in a variety of applications.

### PRIOR ART DOCUMENTS

### Patent Documents

Patent Document 1: JP 3491624 B

### SUMMARY OF INVENTION

### Problems Invention Aims to Solve

Based on Patent Document 1, it is clear that by converting a polyamideimide resin to a water-soluble form, the amount of NMP used in the resin solution can be reduced. However, considering the toxicity of NMP to the human body, safety and hygiene of the working environment during the use of NMP in the industrial field has been identified as an issue, and therefore the development of aqueous polyamideimide resin compositions containing an organic solvent other than NMP would be desirable. In other words, an aqueous polyamideimide resin composition using an organic solvent which, while capable of dissolving polyamideimide resins in a similar manner to NMP, has little effect on the human body and enables an improvement in the working environment would be very desirable.

However, aqueous resin compositions (resin solutions) containing a polyamideimide resin obtained by performing synthesis in an organic solvent other than NMP tend to suffer from poor storage stability. As a result, the physical properties of the polyamideimide resin composition tend to deteriorate during storage, and achieving the desired properties of adhesion to metal substrates and mechanical strength and the like tends to become difficult.

Accordingly, an embodiment of the present invention has an object of providing an aqueous polyamideimide resin composition containing an organic solvent that can dissolve the polyamideimide resin and is capable of improving the working environment, wherein the composition exhibits excellent storage stability and little deterioration in properties.

### Means for Solution of the Problems

Among various investigations, the inventors of the present invention discovered that, compared with polyamideimide resins obtained using NMP, polyamideimide resins obtained using an organic solvent other than NMP were more prone to side reactions, with the properties of the obtained polyamideimide resin being more likely to deteriorate. In particular, it was found that when 4-morpholine carbaldehyde was used during the production of a polyamideimide resin, an aqueous resin composition containing the polyamideimide resin obtained under these conditions was prone to a reduction in viscosity during storage. It is thought that one reason for this reduction in viscosity during storage is that during production of the resin, the reaction between molecules of the same monomer component tends to proceed readily, meaning the number of bonds between units of the same monomer component in the resulting polyamideimide resin increases, and these bonds tend to be prone to hydrolysis by the water contained in the composition. For these types of reasons, the inventors of the present invention discovered that even in those cases where an organic solvent other than NMP is used, by ensuring that the change in the viscosity from before storage to after storage falls within a prescribed range, any deterioration in properties such as the storage stability and the adhesion could be improved, enabling them to complete the present invention. In other words, embodiments of the present invention relate to the aspects described below, but the invention is not limited to these aspects.

One embodiment relates to a polyamideimide resin composition containing a polyamideimide resin (A), 4-morpholine carbaldehyde (B), water (C), and a basic compound (D), wherein the change in viscosity of the composition from before storage to after storage at 60° C. for 7 days is within −30%.

Another embodiment relates to a fluorine-containing coating material containing the polyamideimide resin composition of the embodiment described above and a fluororesin.

Yet another embodiment relates to a substrate or article having a coating film formed using the fluorine-containing coating material of the embodiment described above on at least a portion of a surface of the substrate or article.

The disclosure of this application is related to the subject matter disclosed in prior Japanese Application 2017-149181 filed on Aug. 1, 2017, the entire contents of which are incorporated herein by reference.

### Effects of the Invention

One embodiment of the present invention is able to provide an aqueous polyamideimide resin composition that reduces working environment problems associated with the solvent contained in the composition, and exhibits excellent storage stability and little deterioration in properties. This aqueous polyamideimide resin composition can form a coating film having excellent adhesion, and is ideal as a binder for a fluorine-containing coating material.

### EMBODIMENTS FOR CARRYING OUT THE INVENTION

Preferred embodiments are described below, but the present invention is not limited to these embodiments.

### 1. Polyamideimide Resin Composition

The polyamideimide resin composition is an aqueous composition, and contains at least a polyamideimide resin, 4-morpholine carbaldehyde, water and a basic compound. The resin composition is also a heat-resistant resin composition. In this description, the aqueous polyamideimide resin composition is sometimes referred to as the “polyamideimide resin composition” or the “resin composition”. Further, the terms “resin composition”, “varnish” and “coating material” are sometimes used with the same meaning.

The polyamideimide resin composition preferably exhibits a change in viscosity from before storage to after storage at 60° C. for 7 days that is within −30%. When this change in viscosity is within −30%, any deterioration in the properties following storage is suppressed, and for example, excellent adhesion can be more easily achieved. The change in viscosity is more preferably within −25%. Provided the change in viscosity falls within the above range, changes in the external appearance such as turbidity of the resin composition are unlikely to occur.

The change in viscosity (%) mentioned above refers specifically to a value calculated using (formula 1) shown below.

Change in viscosity (%)=(V2−V1)/V1×100 (Formula 1)

In formula 1, V1 represents the viscosity of the resin composition measured before storage. V2 represents the viscosity measured after the resin composition has been placed in a sealed container, and the sealed container has been stored for 7 days inside a dryer set to a temperature of 60° C.

Measurement of the viscosity is performed in accordance with JIS C 2103, using a B-type viscometer, under conditions including a temperature of 25° C., a No. 3 rotor, and a rotational rate of 12 rpm.

### Polyamideimide Resin

The polyamideimide resin of the component (A) is a resin obtained by reacting a diisocyanate compound and a tribasic acid anhydride or tribasic acid halide as an acid component. An arbitrary combination of a plurality of compounds may also be used for each of these raw material compounds.

There are no particular limitations on the diisocyanate compound, and suitable examples include 4,4′-diphenylmethane diisocyanate, xylylene diisocyanate, 3,3′-diphenylmethane diisocyanate, 3,3′-dimethoxybiphenyl-4,4′-diisocyanate, para-phenylene diisocyanate, hexamethylene diisocyanate, tolylene diisocyanate, naphthalene diisocyanate and isophorone diisocyanate. From the viewpoint of reactivity, the use of 4,4′-diphenylmethane diisocyanate is preferred.

In one embodiment, the polyamideimide resin may be produced using a diamine compound in addition to the diisocyanate. Examples of the diamine compound include diaminodiphenylmethane, 4,4′-diaminodiphenyl ether, 4,4′-diaminodiphenylsulfone, 3,3′-diaminodiphenylsulfone, xylylenediamine, phenylenediamine and isophoronediamine.

Although there are no particular limitations on the tribasic acid anhydride, the use of an aromatic tribasic acid anhydride is preferred, and among such compounds, trimellitic anhydride is preferred. There are no particular limitations on the tribasic acid halide, but tribasic acid chlorides, and particularly aromatic tribasic acid chlorides, can be used favorably. One example is trimellitic anhydride chloride (anhydrotrimellitic acid chloride). From the viewpoint of reducing environmental impact, the use of trimellitic anhydride or the like is preferred.

Besides the tribasic acid anhydride (or tribasic acid halide) described above, other saturated or unsaturated polybasic acids such as dicarboxylic acids and tetracarboxylic dianhydrides may also be used as acid components, provided they do not impair the properties of the polyamideimide resin,

There are no particular limitations on the dicarboxylic acids, and examples include terephthalic acid, isophthalic acid, adipic acid and sebacic acid. There are also no particular limitations on the tetracarboxylic dianhydrides, and examples include pyromellitic dianhydride, benzophenone tetracarboxylic dianhydride and biphenyl tetracarboxylic dianhydride. These compounds may be used individually, or an arbitrary combination of a plurality of compounds may be used.

From the viewpoint of maintaining the properties of the polyamideimide resin, the total amount of carboxylic acids (dicarboxylic acids and tetracarboxylic acids) other than the tribasic acid is preferably within a range from 0 to 50 mol %, and more preferably within a range from 0 to 30 mol %, of all the carboxylic acids.

From the viewpoints of the molecular weight and the crosslinking degree of the produced polyamideimide resin, the usage ratio between the diisocyanate compound (and the diamine compound) and the acid component (the total of the tribasic acid anhydride or tribasic acid halide, and any dicarboxylic acids and tetracarboxylic dianhydrides that are used as required) is preferably adjusted. For example, for each 1.0 mol of the total of all the acid components, the amount of the diisocyanate compound (and diamine compound) is preferably adjusted to an amount within a range from 0.8 to 1.1 mol, more preferably an amount from 0.95 to 1.08 mol, and even more preferably an amount from 1.0 to 1.08 mol.

In one embodiment, the polyamideimide resin may be a blocked polyamideimide resin in which the terminal isocyanate groups have been treated with a blocking agent (a terminal blocking agent). Examples of terminal blocking agents that may be used include alcohols, oximes and lactams, More specifically, examples of the alcohols include lower alcohols of 1 to 6 carbon atoms such as methanol, ethanol and propanol. The oxime may be either an aldoxime or a ketoxime, and for example, 2-butanone oxime or the like can be used favorably. Examples of the lactams include δ-valerolactam and ε-caprolactam. The blocking agent is not limited to the compounds mentioned above, and a combination of a plurality of compound types or a plurality of compounds of the same type may also be used. In those cases where a blocked polyamideimide resin is used in the aqueous polyamideimide resin composition, decomposition caused by hydrolysis can be suppressed, and the storage stability can be more easily improved.

From the viewpoint of ensuring favorable coating film strength, the number average molecular weight of the polyamideimide resin is preferably at least 5,000, more preferably at least 10,000, and even more preferably 15,000 or greater. On the other hand, from the viewpoint of ensuring satisfactory solubility in water, the number average molecular weight of the polyamideimide resin is preferably not more than 50,000, more preferably not more than 30,000, and even more preferably 25,000 or less. In one embodiment, the number average molecular weight of the polyamideimide resin is preferably within a range from 10,000 to 20,000. When a polyamideimide resin having a number average molecular weight within the above range is used, change in the viscosity of the resin composition can be suppressed, and favorable storage stability can be more easily obtained.

The number average molecular weight of the polyamideimide resin can be measured by performing sampling during the resin synthesis, and conducting measurements with a gel permeation chromatograph (GPC) using a calibration curve prepared using standard polystyrenes, By continuing the synthesis of the polyamideimide resin until the targeted number average molecular weight has been achieved, the number average molecular weight can be controlled within the above preferred range. The GPC measurement conditions are described below.

The polyamideimide resin preferably has art acid value, composed of a combination of the carboxyl groups in the resin and other carboxyl groups formed as a result of ring-opening of acid anhydride groups, that is within a range from 10 to 80 mgKOH/g. Provided this acid value is at least 10 mgKOH/g, dissolution or dispersion of the resin in the solvent becomes easier, arid the amount of carboxyl groups is sufficient for reaction with the basic compound, meaning the resin tends to be more easily converted to a water-soluble form. On the other hand, provided the acid value is not more than 80 mgKOH/g, the final polyamideimide resin composition tends to be less likely to gel upon storage. From these viewpoints, the acid value is more preferably at least 25 mgKOH/g, but is preferably not more than 60 mgKOH/g, and more preferably 50 mgKOH/g or less. In one embodiment, the acid value of the polyamideimide resin is preferably within a range from 35 to 50 mgKOH/g. When a polyamideimide resin having art acid value within the above range is used, change in the viscosity of the resin composition can be suppressed, and the storage stability can be more easily improved.

The acid value can be obtained using the following method. First, about 0.5 g of the polyamideimide resin composition is sampled, about 0.15 g of 1,4-diazabicyclo[2.2.2]octane is added to the sample, about 60 g of N-methyl-2-pyrrolidone and about 1 mL of ion-exchanged water are then added, and the resulting mixture is stirred until the polyamideimide resin dissolves completely. This solution is then titrated against a 0.05 mol/L ethanolic potassium hydroxide solution using a potentiometric titrator to obtain the acid value for the polyamideimide resin, representing the combination of carboxyl groups and those carboxyl groups formed as a result of ring-opening of acid anhydride groups.

The amount of the polyatnideimide resin in the composition may be set appropriately in accordance with the intended application. Although there are no particular limitations, from the viewpoint of achieving balance with the other components, in one preferred embodiment, the amount of the polyamideimide resin within the composition is preferably at least 5% by mass, more preferably at least 10% by mass, and even more preferably 15% by mass or greater, but is preferably not more than 50% by mass, more preferably not more than 40% by mass, and even more preferably 30% by mass or less.

### 4-Morpholine Carbaldehyde

The polyamideimide resin composition contains 4-morpholine carbaldehyde of the component (B) as an organic solvent.

The polyamideimide resin composition may also contain one or more organic solvents besides the 4-morpholine carbaldehyde provided the effects of the present invention are not impaired.

Examples of these other organic solvents include one or more polar solvents selected from among N-methyl-2-pyrrolidone, N-ethyl-2-pyrrolidone, γ-butyrolactone, dimethyl sulfoxide, 1,3-dimethyl-2-imidazolidine, dimethylacetamide, dimethylformamide, and N-acetylmorpholine and the like. In addition, one or more co-solvents may also be used, including ether compounds such as anisole, diethyl ether and ethylene glycol; ketone compounds such as acetophenone, methyl ethyl ketone, methyl isobutyl ketone, cyclohexanone and cyclopentanone; aromatic hydrocarbon solvents such as xylene and toluene; and alcohols such as ethanol and 2-propanol.

From the viewpoint of the miscibility with water, the amount of the 4-morpholine carbaldehyde, or the organic mixed solvent containing the 4-morpholine carbaldehyde, is preferably not more than 90% by mass, and more preferably 80% by mass or less, of the total mass of the organic solvent and water (namely, the total solvent). In the case of an organic mixed solvent, from the viewpoint of satisfactorily realizing the effects of the preferred embodiments, the amount of the 4-morpholine carbaldehyde within the mixed organic solvent is preferably at least 50% by mass, and is more preferably 80% by mass or greater.

### Water

The polyamideimide resin composition also contains the water of e component (C). Ion-exchanged water can be used favorably as the water.

From the viewpoint of improving the solubility of the polyamideimide resin in the water, the amount of water in the composition is preferably at least 10% by mass, more preferably at least 15% by mass, and even more preferably 25% by mass or greater. On the other hand, the amount of water in the composition is preferably not more than 80% by mass, more preferably not more than 70% by mass, and even more preferably 60% by mass or less. Further, relative to the total mass of the organic solvent containing the 4-morpholine carbaldehyde and the water, namely relative to the total mass of all solvent in the resin composition, the amount of water is preferably at least 10% by mass (water ratio to the all solvent is at least 10% by mass), more preferably at least 20% by mass, and even more preferably 25% by mass or greater, but on the other hand, the water ratio to the all solvent is preferably not more than 90% by mass, and more preferably 50% by mass or less.

### Basic Compound

In one embodiment, the polyamideimide resin composition may be composed of the above components (A), (B) and (C). However, in order to improve the solubility of the polyamideimide resin in water, the composition preferably also contains a basic compound. Accordingly, in a preferred embodiment, the polyamideimide resin composition also contains a basic compound as the component (D). The basic compound improves the solubility of the polyamideimide resin in water by reacting with the carboxyl groups in the polyamideimide resin to form salts.

Specific examples of the basic compounds include: alkylamines such as triethylamine, tributylamnine, N,N-dimethylcyclohexylamine, N,N-dimethylbenzylamine, triethylenediamine, N-methylmorpholine, N,N,N′,N′-tetramethylethylenediamine, N,N,N′,N″,N″-pentamethyldiethylenetriamine, N,N′,N′-trimethylaminoethylpiperazine, diethylamine, diisopropylamine, dibutylamine, ethylamine, isopropylamine and butylamine; and alkanolamines such as monoethanolamine, diethanolamine, triethanolamine, dipropanolamine, tripropanolamine, N-ethylethanolamine, N,N-dimethylethanolamine, N,N-diethylethanolamine, cyclohexanolamine, N-methylcyclohexanolamine and N-benzylethanolamine.

Besides the basic compounds mentioned above, caustic alkalis such as sodium hydroxide and potassium hydroxide, or ammonia water or the like may also be used in combination with the above basic compounds.

In one embodiment, an alkanolamine is preferably used as the basic compound, and among such alkanolamines, the use of N,N-dimethylethanolamine is particularly preferred.

From the viewpoints of facilitating the conversion of the polyamideimide resin to a water-soluble form, and improving the coating film strength, the basic compound is preferably used in an amount of 2.5 to 10 equivalents, and more preferably at least 4 equivalents but not more than 8 equivalents, relative to the acid value composed of the combination of carboxyl groups and ring-opened acid anhydride groups contained within the polyamideimide resin.

In one embodiment, the blend amount of the basic compound, relative to the acid value composed of the combination of carboxyl groups and ring-opened acid anhydride groups contained within the polyamideimide resin, is preferably within a range from 4.5 to 6 equivalents, and more preferably from 4.5 to 5.5 equivalents.

in order to achieve salt formation between the polyamideimide resin and the basic compound, the basic compound may be added to the polyamideimide resin composition containing water. Alternatively, the basic compound may be added to an organic solvent solution of the polyamideimide resin that contains no water, and water then added. The temperature for salt formation is preferably within a range from 0° C. to 200° C., and more preferably from 40° C. to 130° C.

### Other Components

The polyamideimide resin composition of one embodiment may also contain, in addition to the components (A) to (D) described above, optional components that may be added in accordance with the intended use. This resin composition may also contain a polyamideimide resin other than the polyamideimide resin described above.

The polyamideimide resin composition can be used favorably as a coating material. When the polyamideimide resin is used as a coating material, optional components such as pigments, fillers, antifoaming agents, preservatives and surfactants may be added as required. Resins other than the polyamideimide resin may also be included, and details of such resins are disclosed below in the section relating to the coating material.

### 2. Method for Producing Polyamideimide Resin

The method for producing the polyamideimide resin includes a polymerization step of reacting a diisocyanate compound and a tribasic acid anhydride and/or tribasic acid halide in an organic solvent. In a preferred embodiment, the organic solvent contains 4-morpholine carbaldehyde. The raw material compounds used are as described above in the section relating to the polyamideimide resin.

In the case of production of a blocked polyamideimide resin, in addition to the polymerization step described above, the method also includes a step of blocking the terminal isocyanate groups of the polyamideimide resin with a blocking agent such as an alcohol. As described below, the polymerization step and the blocking step may be performed as separate steps, but both steps may also be performed simultaneously, meaning the polymerization and the blocking are performed at the same time.

in the polymerization reaction, the 4-morpholine carbaldehyde or the organic solvent containing the 4-morpholine carbaldehyde can be used as the polymerization solvent (the synthesis solvent). In such cases, the obtained polymerized solution can be used without further modification as a polyamideimide resin composition component in a coating material or the like. In other words, the 4-morpholine carbaldehyde may be used as both the synthesis solvent and the solvent for the coating material described below. Examples of other organic solvents that may be used besides the 4-morpholine carbaldehyde are as described above in the section relating to the polyamideimide resin composition.

Although there are no particular limitations on the amount of solvent used during the polymerization, using an amount of solvent of 50 to 500 parts by mass per 100 parts by mass of the total mass of the diisocyanate component (and diamine component) and the acid component is preferred from the viewpoint of the solubility of the resin.

Although there are no particular limitations on the reaction temperature, a temperature of 80 to 180° C. is generally preferred.

In order to reduce the effect of moisture in the air, the polymerization reaction is preferably conducted under an atmosphere of nitrogen or the like.

In one embodiment, the polymerization step is preferably performed by raising the temperature to 70 to 100° C. and holding that temperature for a prescribed time, and then raising the temperature further to 110 to 140° C. and holding that temperature for a prescribed time. When an organic solvent other than NMP is used during production of a polyamideimide resin, reactions between molecules of the same monomer component tend to proceed readily. As a countermeasure, by adjusting the heating conducted in the polymerization step to a two-stage process as described above, reactions between molecules of the same monomer component can be suppressed, and a polyamideimide resin of a preferred structure and molecular weight can be more easily obtained. In one embodiment, in order to prepare an aqueous polyamideimide resin composition, a polyamideimide resin produced using the two-stage heating conditions described above can be used particularly favorably. There are no particular limitations on the heating time (the reaction time), which may be adjusted as appropriate.

The polyamideimide resin can be produced, for example, using any of the following procedures.

(1) A method of synthesizing the polyamideimide resin by using and reacting the acid component and the diisocyanate component (and diamine component) in a single batch.
(2) A method of reacting the acid component with an excess of the diisocyanate component (and diamine component) to synthesize an amideimide oligomer having isocyanate groups or amino groups at the terminals, and then synthesizing the polyamideimide resin by adding additional acid component to react with the terminal isocyanate groups (and amino groups).
(3) A method of reacting an excess of the acid component with the diisocyanate component (and diamine component) to synthesize an amideimide oligomer having acid groups or acid anhydride groups at the terminals, and then synthesizing the polyamideimide resin by adding additional diisocyanate component and/or diamine component to react with the terminal acid groups or acid anhydride groups.

In the case of synthesis of a blocked polyamideimide resin, the blocking agent may be reacted during the synthesis of the resin, so that the above polymerization step and blocking step occur simultaneously, or the blocking agent may be reacted with the resin following the polymerization step. In the former case, the blocking agent is typically added to the polymerization solvent.

If the total amount of diisocyanate used during the resin production is deemed to be 100 parts by mass, then the amount of the terminal blocking agent added during blocking is preferably within a range from 1.0 to 10.0 parts by mass. From the viewpoint of the storage stability of the obtained resin composition, the above amount is more preferably from 2.5 to 5.0 parts by mass.

### 3. Method for Producing Polyamideimide Resin Composition

The polyamideimide resin composition of the preferred embodiment described above, containing the polyamideimide resin (A), 4-morpholine carbaldehyde (B), water (C) and the basic compound (D), can be produced favorably by adding water to the reaction solution containing the polyamideimide resin obtained using the above method for producing a polyamideimide resin.

In other words, in one embodiment, the method for producing a polyamideimide resin composition includes:

a polymerization step of reacting a diisocyanate compound and a tribasic acid anhydride and/or tribasic acid halide in an organic solvent containing 4-morpholine carbaldehyde, and

a step of adding a basic compound to the obtained resin solution, and then adding water.

In another embodiment, the production method includes:

a polymerization step of reacting a diisocyanate compound and a tribasic acid anhydride and/or tribasic acid halide in an organic solvent, and

a step of adding a basic compound to the obtained resin solution, and then adding water and a diluting organic solvent.

In this embodiment, the organic solvent used in the polymerization step and/or the diluting organic solvent contains at least 4-morpholine carbaldehyde.

In those cases where a blocked polyamideimide resin is used as the polyamideimide resin, the blocking step may be performed simultaneously with the polymerization step, or a separate blocking step may be added.

### 4. Coating Material

The polyamideimide resin composition can be diluted with water to an arbitrary concentration, and can form a coating film that exhibits excellent adhesion to substrates even after high-temperature baking, arid can therefore be used favorably as a coating material. When the polyamideimide resin composition is used as a coating material, the composition is preferably diluted with water or an organic solvent to obtain a viscosity that is appropriate for the coating film formation method or the like.

Further, because this polyamideimide resin composition also exhibits excellent miscibility with fluororesin water dispersions, it can be used favorably as a binder for a fluororesin. In other words, the polyamideimide resin composition can be used favorably as a fluorine-containing coating material into which a fluororesin has been mixed.

A fluorine-containing coating material containing a fluororesin and either the polyamideimide resin composition or a polyamideimide resin obtained using the above method for producing a blocked polyamideimide resin exhibits excellent coating film adhesion, heat resistance and hardness, and is therefore ideal as a coating material for household electrical appliances or kitchen utensils.

This fluorine-containing coating material designed for household electrical appliances or kitchen utensils is composed of a mixed system containing a fluororesin that generates non-tacky properties, and a polyamideimide resin that generates good adhesion to substrates, and in order to ensure that the fluororesin can be oriented at the coating film surface during baking of the coating film, high-temperature baking at a temperature in the vicinity of 400° C. is performed to melt the fluororesin.

The polyamideimide resin described above is preferably included within the coating material in an amount of 1 to 50% by mass in order to ensure satisfactory manifestation of the resin functions. A combination of a plurality of different types of polyamideimide resins may be used, and a blocked polyamideimide resin may be included as one component.

### Fluororesin

The properties required of the mixed fluororesin include non-tackiness, corrosion resistance, heat resistance and chemical resistance, and examples of fluororesins that can be used favorably include mainly tetrafluoroethylene resins, tetrafluoroethylene-perfluoro vinyl ether copolymers, and tetrafluoroethylene-hexafluoropropylene copolymers. A combination of a plurality of these resins may also be used.

There are no particular limitations on the form of the fluororesin, and either an aqueous dispersion or a powder may be used. Although there are no particular limitations on the amount added of the fluororesin, from the viewpoint of obtaining a coating film having a good balance between superior adhesion and non-tackiness and the like, the amount of the fluororesin is preferably from 50 to 800 parts by mass, and more preferably from 100 to 500 parts by mass, per 100 parts by mass of the polyamideimide resin.

### Other Components

If necessary, the coating material or the fluorine-containing coating material may also contain added polyethersulfone resins (PES), polyimide resins (PI), polyamide resins, epoxy compounds, isocyanate compounds, or melamine compounds or the like, either individually or in mixtures.

In one preferred embodiment, the coating material may contain an epoxy compound (epoxy resin). By adding an epoxy compound, the thermal, mechanical and electrical properties of the polyamideimide resin can be further improved. Further, epoxy compounds (epoxy resins), melamine compounds (melamine resins) and isocyanate compounds enable further improvement in the adhesion of the coating film, and are consequently preferred.

Examples of the epoxy compounds include bisphenol epoxy resins (such as bisphenol-A epoxy resins, hydrogenated bisphenol-A epoxy resins, bisphenol-F epoxy resins, brominated bisphenol-A epoxy resins, and bisphenol-S epoxy resins), biphenyl epoxy resins, phenol novolac epoxy resins, brominated phenol novolac epoxy resins, o-cresol novolac epoxy resins, flexible epoxy resins, polyfunctional epoxy resins, amine epoxy resins, heterocyclic ring-containing epoxy resins, alicyclic epoxy resins, triglycidyl isocyanurate, and bixylenol epoxy resins. These epoxy compounds may be used individually, or a combination of a plurality of compounds may be used.

The epoxy compound may be added alone and reacted with the polyamideimide resin, but the epoxy compound may also be added together with a curing agent or a curing accelerator or the like so that residual unreacted epoxy compound is less likely to remain after curing.

Examples of the isocyanate compounds include polyisocyanates of hexamethylene diisocyanate such as Duranate, and polyisocyanates synthesized from 4,4′-diphenylmethane diisocyanate, The weight average molecular weight of these polyisocyanates is preferably from 500 to 9,000, and more preferably from 1,000 to 5,000.

There are no particular limitations on the melamine compounds, and examples include methylol group-containing compounds obtained by reacting melamine with formaldehyde or para-formaldehyde or the like. These methylol groups are preferably etherified with an alcohol having 1 to 6 carbon atoms.

In terms of the amount of these epoxy compounds, isocyanate compounds and melamine compounds included in the coating material, from the viewpoint of achieving an improvement effect in the adhesion, the amount of each of these compounds per 100 parts by mass of the polyamideimide resin is preferably at least 1 part by mass, and more preferably at least 5 parts by mass. On the other band, from the viewpoint of maintaining the heat resistance and strength of the polyamideimide resin composition, the amount of each of these compounds is preferably not more than 40 parts by mass, and more preferably 30 parts by mass or less.

The coating material preferably also includes a surfactant according to need. Although there are no particular limitations on the surfactant, a surfactant which ensures that the coating material composition mixes uniformly and does not undergo layer separation or phase separation before the coating film dries, and which does not leave a large amount of residual matter following baking of the coating film, is preferred.

Although there are no particular limitations on the amount of the surfactant, in order to maintain a uniform mixed state for the coating material composition, and ensure that a large amount of residual surfactant is not retained after baking, adversely affecting the film formation properties, the amount of the surfactant in the coating material is preferably within a range from 0.01 to 10% by mass, and more preferably from 0.5 to 5% by mass.

In order to improve the water resistance and the like of the coating film, the coating material may also contain a filler. The type of filler used can be selected in accordance with the intended application of the coating film, with due consideration of factors such as the water resistance and the chemical resistance of the filler, and is preferably a filler that does not dissolve in water. Specific examples of the filler include metal powders, metal oxides (such as aluminum oxide, zinc oxide, tin oxide and titanium oxide), glass beads, glass flakes, glass particles, ceramics, silicon carbide, silicon oxide, calcium fluoride, carbon black, graphite, mica and barium sulfate. Any of these fillers may be used individually, or a combination of a plurality of fillers may be used.

There are no particular limitations on the coating method used for the coating material, and conventional coating methods such as dip coating, spray coating and brush application can be employed. The volume of solvent is preferably adjusted appropriately, with the concentration diluted to a level that is appropriate for the coating method.

Following application of e coating material, the material is dried (preliminary drying) and cured (baked) to form a coating film. The conditions for the drying and curing are not particularly limited, and are preferably set appropriately in accordance with the heat resistance and the like of the substrate being used. In order to ensure favorable adhesion and toughness for the coating film, heating is preferably performed at a temperature of 250° C. or higher. In the case of a fluorine-containing coating material, in order to ensure orientation of the fluororesin at the coating film surface during coating film baking, high-temperature baking at a temperature in the vicinity of 400° C. is preferably conducted to melt the fluororesin, and performing the baking at a temperature of 330° C. to 420° C. for a period of about 10 minutes to 30 minutes is preferred. As a result of the baking, the fluororesin migrates toward the coating film surface, and melts to form a film.

### 5. Substrate or Article

A substrate or article of an embodiment of the present invention has a coating film formed from the above fluorine-containing coating material on at least a portion of a surface of the substrate or article.

The coating film can be formed on the surface of any type of substrate or article in which the coating film requires good safety properties and boiling resistance and the like. The surface on which the coating film is formed is preferably a surface that is exposed to water vapor and/or a surface that is exposed to high temperatures.

Examples of the article include household electrical cooking appliances and kitchen utensils and the like, Examples of the kitchen utensils include utensils for which there is a possibility of contact with boiling water or steam, such as pots, pressure cookers and fry pans, and more specifically, pots, pressure cookers and fry pans having the coating film described above formed on the inside surface, and lids for these utensils, Further, specific examples of the household electrical cooking appliances (kitchen electrical appliances) include rice cookers, hot plates, electric kettles, microwave ovens, oven ranges and gas ranges, and more specifically, inner pots and lids of rice cookers having the coating film described above formed on the inside surfaces thereof, microwave ovens having the coating film formed on the interior surface of the oven, and the top plates of gas ranges having the coating film formed on the surface.

The substrate is preferably a substrate that is used in these types of household electrical cooking appliances and kitchen utensils.

The polyamideimide resin composition according to an embodiment of the present invention, and a coating material (including a fluorine-containing coating material) containing this polyamideimide resin as a coating film component have low toxicity and excellent storage stability. Further, by applying the polyamideimide resin composition or coating material to a target article and then conducting curing, a coating film can be formed which, compared with conventional coating films, exhibits excellent adhesion to the substrate and excellent steam resistance, even after high-temperature baking. Accordingly, the present invention has enormous benefits in a large variety of applications that require safety, boiling resistance or steam resistance, and heat resistance for surface coating films, including household electrical appliances and cooking utensils.

In addition, because this polyamideimide resin composition is an aqueous resin composition, the environmental impact can be reduced, and a contribution can also be made to VOC reduction.

Although the above description has provided detailed descriptions of a coaling material and a fluorine-containing coating material, the polyamideimide resin composition can also be mixed with other resin materials or the like, and used to produce molded items by molding techniques such as extrusion molding.

### EXAMPLES

A variety of examples are described below, but the preferred embodiments of the present invention are not limited to these examples, and of course also incorporate many embodiments other than these examples based on the scope of the present invention.

The number average molecular weight and the acid value of the various polyamideimide resins were measured under the following conditions.

### Number Average Molecular Weight

GPC apparatus: HLC-8320GPC manufactured by Tosoh Corporation

Detector: RI detector manufactured by Tosoh Corporation

Wavelength: 270 nm

Data processing unit: ATT 8

Columns: Gelpack GL-S300MDT-5×2

Column size: 8 mmø×300 mm

Column temperature: 40° C.

Solvent: DMF/THF=1./1 (liter)+0.06 M phosphoric acid+0.06 M lithium bromide

Sample concentration: 5 mg/mL

Injection volume: 5 μL

Pressure: 49 kgf/cm² (4.8×10⁶ Pa)

Flow rate: 1.0 mL/min

### Acid Value

First, 0.5 g of the polyamideimide resin composition was sampled, 0.15 g of 1,4-diazabicyclo[2.2.2]octane was added to the sample, about 60 g of N-methyl-2-pyrrolidone and about 1 mL of ion-exchanged water were then added, and the resulting mixture was stirred until the polyamideimide resin dissolved completely. This solution was then titrated against a 0.05 mol/L ethanolic potassium hydroxide solution using a potentiometric titrator to obtain the acid value for the polyamideimide resin, representing the combination of carboxyl groups and those carboxyl groups formed as a result of ring-opening of acid anhydride groups within the polyamideimide resin.

### Example 1

A flask fitted with a thermometer, a stirrer and a condenser was charged with 309.5 g of trimellitic anhydride, 403.2 g of 4,4′-diphenylmethane diisocyanate and 712.7 g of 4-morpholine carbaldehyde, and the resulting mixture was stirred under a stream of dry nitrogen while the temperature was gradually raised to 90° C. over a period of one hour. Following heating at this temperature for three hours, the temperature was gradually raised to 130° C. while particular care was taken over the rapid foaming of carbon dioxide gas that was generated by the reaction, and after continued heating at 130° C. for three hours from the start of the temperature raising process, the reaction was halted, thus obtaining a polyamideimide resin solution.

The non-volatile fraction (200° C., 2 hours) of this polyamideimide resin solution was 48% by mass. Further, the number average molecular weight of the polyamideimide resin was 15,000, and the acid value, composed of a combination of carboxyl groups and other carboxyl groups formed as a result of ring-opening of acid anhydride groups, was 45 mgKOH/g.

Subsequently, 1,200 g of the thus obtained polyamideimide resin solution was placed in a flask fitted with a thermometer, a stirrer and a condenser, and the solution was stirred under a stream of dry nitrogen while the temperature was gradually raised to 70° C. When the temperature reached 70° C., 205.9 g (5 equivalents) of N,N-dimethylethanolamine was added, and following thorough stirring with the temperature maintained at 70° C., ion-exchanged water was added gradually to the flask under constant stirring. The ion-exchanged water was added until a final total of 624.0 g of water (water ratio to the all solvent: 50% by mass) had been added, thus obtaining a transparent and uniform polyamideimide resin composition (aqueous heat-resistant resin composition).

### Example 2

A flask fitted with a thermometer, a stirrer and a condenser was charged with 200.8 g of trimellitic anhydride, 262.6 g of 4,4′-diphenylmethane diisocyanate and 501.9 g of 4-morpholine carbaldehyde, and the resulting mixture was stirred under a stream of dry nitrogen while the temperature was gradually raised to 80° C. over a period of one hour. Following heating at this temperature for 4 hours, the temperature was gradually raised to 120° C. while particular care was taken over the rapid foaming of carbon dioxide gas that was generated by the reaction, and after continued heating at 120° C. for 4 hours from the start of the temperature raising process, the reaction was halted, thus obtaining a polyamideimide resin solution.

The non-volatile fraction (200° C., 2 hours) of this polyamideimide resin solution was 45©% by mass. Further, the number average molecular weight of the polyamideimide resin was 18,000, and the acid value, composed of a combination of carboxyl groups and other carboxyl groups formed as a result of ring-opening of acid anhydride groups, was 40 mgKOH/g.

Subsequently, 620 g of the thus obtained polyamideimide resin solution was placed in a flask fitted with a thermometer, a stirrer and a condenser, and the solution was stirred under a stream of dry nitrogen while the temperature was gradually raised to 80° C. When the temperature reached 80° C., 97.5 g (5 equivalents) of N,N-dimethylethanolamine was added, and following thorough stirring with the temperature maintained at 80° C., ion-exchanged water was added gradually to the flask under constant stirring. The ion-exchanged water was added until a final total of 279.0 g of water (water ratio of the all solvent: 45% by mass) had been added, thus obtaining a transparent and uniform polyamideimide resin composition (aqueous heat-resistant resin composition).

### Example 3

A flask fitted with a thermometer, a stirrer and a condenser was charged with 791.2 g of trimellitic anhydride, 463.8 g of 4,4′-diphenylmethane diisocyanate, 598.6 g of 3,3′-dimethoxybiphenyl-4,4′-diisocyanate and 2,265.4 g of 4-morpholine carbaldehyde, and the resulting mixture was stirred under a stream of dry nitrogen while the temperature was gradually raised to 100° C. over a period of two hours. Following heating at this temperature for two hours, the temperature was gradually raised to 130° C. while particular care was taken over the rapid foaming of carbon dioxide gas that was generated by the reaction, and after continued heating at 130° C. for 5 hours from the start of the temperature raising process, the reaction was halted, thus obtaining a polyamideimide resin solution.

The non-volatile fraction (200° C., 2 hours) of this polyamideimide resin solution was 42% by mass. Further, the number average molecular weight of the polyamideimide resin was 15,000, and the acid value, composed of a combination of carboxyl groups and other carboxyl groups formed as a result of ring-opening of acid anhydride groups, was 45 mgKOH/g.

Subsequently, 3,200 g of the thus obtained polyamideimide resin solution was placed in a flask fitted with a thermometer, a stirrer and a condenser, and the solution was stirred under a stream of thy nitrogen while the temperature was gradually raised to 70° C. When the temperature reached 70° C., 432.4 g (4,5 equivalents) of N,N-dimethylethanolamine was added, and following thorough stirring with the temperature maintained at 70° C., ion-exchanged water was added gradually to the flask under constant stirring. The ion-exchanged water was added until a final total of 1,237.3 g of water (water ratio to the all solvent: 40% by mass) had been added, thus obtaining a transparent and uniform polyamideimide resin composition (aqueous heat-resistant resin composition).

### Comparative Example 1

A flask fitted with a thermometer, a stirrer and a condenser was charged with 512.6 g of trimellitic anhydride, 667.7 g of 4,4′-diphenylimethane diisocyanate and 1,180.3 g of 4-morpholine carbaldehyde, and the resulting mixture was stirred under a stream of dry nitrogen while the temperature was gradually raised to 110° C. over a period of one hour. Following heating at this temperature for one hour, the temperature was gradually raised to 140° C. while particular care was taken over the rapid foaming of carbon dioxide gas that was generated by the reaction, and after continued heating at 140° C. for three hours from the start of the temperature raising process, the reaction was halted, thus obtaining a polyamideimide resin solution.

The non-volatile fraction (200° C., 2 hours) of this polyamideimide resin solution was 48% by mass. Further, the number average molecular weight of the polyamideimide resin was 9,000, and the acid value, composed of a combination of carboxyl groups and other carboxyl groups formed as a result of ring-opening of acid anhydride groups, was 50 mgKOH/g.

Subsequently, 1,800 g of this polyamideimide resin solution was placed in a flask fitted with a thermometer, a stirrer and a condenser, and the solution was stirred under a stream of dry nitrogen while the temperature was gradually raised to 60° C. When the temperature reached 60° C., 274.6 g (4 equivalents) of N,N-dimethylethanolamine was added, and following thorough stirring with the temperature maintained at 60° C., ion-exchanged water was added gradually to the flask under constant stirring. The ion-exchanged water was added until a final total of 936.0 g of water (water ratio to the all solvent: 50% by mass) had been added, thus obtaining a transparent and uniform polyamideimide resin composition (aqueous heat-resistant resin composition).

### Change in Viscosity (%)

For each of the polyamideimide resin compositions (varnishes) obtained in the above examples and comparative example, the procedure described below was used to calculate the change in viscosity (%) of the composition from before storage to after storage at 60° C. for 7 days.

First, the viscosity of the polyamideimide resin composition (varnish) was measured before storage. Subsequently, a fixed amount of the resin composition (varnish) was placed in a sealed container, the sealed container was stored for 7 days inside a dryer set to a temperature of 60° C., and the viscosity of the composition was then remeasured. Using these measure values, the change in viscosity (%) was calculated using (formula 1) shown below.

Change in viscosity (%)=(V2−V1)/V1×100 (Formula 1)

In formula 1, V1 represents the viscosity measured before storage. V2 represents the viscosity measured after storage for 7 days at 60° C.

The viscosity measurements were performed in accordance with JIS C 2103, using a B-type viscometer, under conditions including a temperature of 25° C., a No. 3 rotor, and a rotational rate of 12 rpm.

### Evaluations

### Varnish External Appearance

Each of the polyamideimide resin compositions (varnishes) obtained in the above examples and comparative example was stored in a sealed container in an environment at 60° C., and the external appearance of the varnish was inspected visually after 7 days.

### Adhesion Reduction

Each of the polyamideimide resin compositions (test coating materials) obtained in the above examples and comparative example was applied to an aluminum substrate (1×50×150 mm, manufactured by Paltec Test Panels Co., Ltd.). An adhesion test was then performed in accordance with the procedure described below.

Specifically, each of the above substrates to which a test coating material had been applied was subjected to preliminary drying at 80° C. for 10 minutes, and was then baked at 400° C. for 10 minutes, thus obtaining a coating film having an average film thickness of 10 μm across 5 locations. Cuts were then formed in this coating film to generate 1 mm squares in a 10×10 grid pattern, portions of an adhesive tape (manufactured by Nichiban Co., Ltd.) were adhered to, and then peeled from, the surface 5 times, and the number of remaining squares was counted.

The above adhesion test was performed using a sample of the resin composition before storage under heat, and also using a sample of the resin composition that had been stored at 60° C. for 7 days, and the reduction in adhesion was then calculated using (formula 2) shown below.

Reduction in adhesion (%)=(A2−A1)/A1×100 (Formula 2)

In formula 2, A1 represents the adhesion evaluation result using the resin composition before storage. A2 represents the adhesion evaluation result using the resin composition after storage at 60° C. for 7 days.

The various evaluation results are shown in Table 1.

TABLE 1

| | | | | Comparative |
|---|---|---|---|---|
| Item | Example 1 | Example 2 | Example 3 | Example 1 |
| Polyamideimide resin | 4-morpholine carbaldehyde | | | |
| polymerization solvent | | | | |
| Water ratio to the all solvent | 50 | 40 | 40 | 50 |
| (% by mass) | | | | |
| Change (%) in viscosity from before | −20 | −25 | −28 | −50 |
| storage to after storage at 60° C. for 7 days | | | | |
| External appearance after storage at | transparent | transparent | transparent | turbid |
| 60° C. for 7 days | | | | |
| Change (%) in adhesion from before | 0 | 0 | −4 | −70 |
| storage to after storage at 60° C. for 7 days | | | | |

As shown in Table 1, the polyamideimide resin compositions obtained in the examples each exhibited a change in viscosity within −30%, and exhibited either no reduction in adhesion after storage at 60° C. for 7 days, or extremely little reduction. In contrast, the resin composition obtained in Comparative Example 1 exhibited a change in viscosity that exceeded −30%, and the adhesion after storage at 60° C. for 7 days displayed a dramatic reduction. Further, the external appearance of the polyamideimide resin compositions of the examples after storage at 60° C. for 7 days was transparent in each case. In contrast, the external appearance of the polyamideimide resin composition of Comparative Example 1 after storage at 60° C. for 7 days showed turbidity. Based on these results, it was evident that for resin compositions using a solvent other than NMP, by ensuring that the reduction in viscosity of the composition from before storage to after storage at 60° C. for 7 days is within a prescribed range, excellent storage stability can be obtained, and any deterioration in properties can be suppressed.

1-7. (canceled)

8. A method for producing a polyamideimide resin composition which contains a polyamideimide resin (A), 4-morpholine carbaldehyde (B), water (C), and a basic compound (D), wherein a change in viscosity of the composition from before storage to after storage at 60° C. for 7 days is within −30%, comprising:
a polymerization step of reacting a diisocyanate compound and a tribasic acid anhydride and/or tribasic acid halide in an organic solvent containing 4-morpholine carbaldehyde (B) to form a reaction solution containing the polyamideimide resin (A);
a step of adding the basic compound (D) to the reaction solution; and
a step of adding water (C) into the reaction solution containing the basic compound (D),
wherein the polymerization step is performed by a two-stage heating process comprising a first heating at 70 to 100° C. and a second heating at 110 to 140° C.

9. The method for producing the polyamideimide resin composition according to claim 8, wherein a number average molecular weight of the polyamideimide resin (A) is within a range from 5,000 to 50,000.

10. The method for producing the polyamideimide resin composition according to claim 8, wherein an acid value of the polyamideimide resin (A), composed of a combination of carboxyl groups and other carboxyl groups formed as a result of ring-opening of acid anhydride groups, is within a range from 10 to 80 mgKOH/g.

11. The method for producing the polyamideimide resin composition according to claim 8, wherein an amount of the water (C) is at least 10% by mass relative to a total mass of the polyamideimide resin composition.

12. The method for producing the polyamideimide resin composition according to claim 8, wherein a number average molecular weight of the polyamideimide resin (A) is within a range from 10,000 to 20,000.

13. The method for producing the polyamideimide resin composition according to claim 8, further containing a step of blocking terminal isocyanate groups of the polyamideimide resin with a blocking agent.

14. The method for producing the polyamideimide resin composition according to claim 8, wherein the first heating is performed for 2 to 4 hours, and the second heating is performed for 3 to 5 hours.
